(19) United States
(12) Patent Application Publication
(10) Pub. No.: US 2014/0238598 A1
(43) Pub. Date: Aug. 28, 2014

(54) LAMINATE STRUCTURE, METHOD FOR FORMING, AND METHOD OF USE THEREOF

(71) Applicants: Christopher David Peters, Rolla, MO (US); Harold Miles Hendrickson, Rolla, MO (US); Richard Ray Byfield, Rolla, MO (US)

(72) Inventors: Christopher David Peters, Rolla, MO (US); Harold Miles Hendrickson, Rolla, MO (US); Richard Ray Byfield, Rolla, MO (US)

(21) Appl. No.: 14/186,521

(22) Filed: Feb. 21, 2014

Related U.S. Application Data
(60) Provisional application No. 61/768,145, filed on Feb. 22, 2013.

(51) Int. Cl. B32B 21/08

(52) U.S. Cl. CPC B32B 21/08
USPC 156/308.2; 428/537.1; 428/337; 428/339; 156/60

(57) ABSTRACT

A method for forming a laminate structure is provided. The method includes selecting a sheet layer that includes a melamine-based resin and selecting a substrate that includes wood, phenolic resin, zinc borate, and a water repellant agent. Heat and pressure are applied to the sheet layer and substrate at a temperature of from about 339° F. to 375° F., at a pressure of from about 23 bar to about 35 bar, and for a predetermined duration of from about 12 seconds to about 22 seconds. The sheet layer is then coupled to the substrate to form the laminate structure.

### BACKGROUND

The present disclosure relates generally to laminate structures, a related method for forming the laminate structures, and a method of use thereof.

At least some known engineered wood structures such as particleboard and fibreboard are structures composed primarily of wood that may be used in a variety of applications. Such structures are fabricated by forming a composition of sawdust, wood chips, sawmill shavings, wood fiber, or other suitable wood particles with a synthetic binder, and applying heat and pressure to the composition to fabricate structures having any suitable dimensions. At least some known engineered wood structures may be used in lieu of pure wood products in applications such as furniture construction. When compared to pure wood products, such structures generally have a greater density, are less prone to seasonal distortion, and do not include knots or rings that could compromise the integrity of the structure to be built. However, engineered wood structures are generally only intended for indoor use because of its susceptibility to retain moisture in a high moisture environment.

Extira® is an engineered wood structure fabricated from a wood-based composition that includes additives to remedy at least some known deficiencies in traditional particleboard and fibreboard structures. For example, Extira® includes additives such as a water repellant, a flame retardant, and a wood preservation agent. When compared to other known engineered wood products, Extira® generally has a greater density, is rated for exterior use, and is moisture, rot, and termite resistant.

One known method of improving the aesthetic appearance and weather resistance of engineered wood structures for use in applications such as furniture construction is to apply a decorative and/or protective paper or veneer to a surface of the wood structure. Generally, the decorative paper includes a design, color, or texturing on one side of the paper and an adhesive impregnated within an opposing side of the paper. The decorative paper is coupled to the wood structure, and heat and pressure is applied thereon to bond the paper to the structure. While applying decorative paper to traditional particleboard and fibreboard may be completed successfully over a wide range of process conditions, the properties and composition of Extira® make it difficult to laminate decorative paper thereto with a consistent rate of success.

Therefore, a need exists for engineered wood structures that are resistant to moisture penetration, rot and termite corrosion, and that have an improved aesthetic appearance. Further, a need exists for defined process conditions to fabricate such improved engineered wood structures with a consistent success rate.

### BRIEF SUMMARY

In one embodiment, a laminate structure is provided. The laminate structure includes a substrate and a sheet layer coupled to the substrate. The substrate includes wood, phenolic resin, biocide, and a water repellant agent, and the sheet layer includes a melamine-based resin impregnated therein.

In another embodiment, a method for forming a laminate structure is provided. The method includes selecting a sheet layer that includes a melamine-based resin and selecting a substrate that includes wood, phenolic resin, biocide, and a water repellant agent. Heat and pressure are applied to the sheet layer and substrate at a temperature of from about 339° F. to 375° F., at a pressure of from about 23 bar to about 35 bar, and for a predetermined duration of from about 12 seconds to about 22 seconds. The sheet layer is then coupled to the substrate to form the laminate structure.

In yet another embodiment, a method for using a laminate structure is provided. The method includes selecting a laminate structure that includes a substrate and a sheet layer coupled to the substrate. The substrate includes wood, phenolic resin, biocide, and a water repellant agent, and the sheet layer includes a melamine-based resin impregnated therein. The method also includes installing the laminate structure in a non-structural construction application.

### BRIEF DESCRIPTION OF THE DRAWINGS

FIG. 1 is a sectional schematic view of an exemplary laminate structure.

### DETAILED DESCRIPTION

The present disclosure generally provides for a laminate structure, a method for forming a laminate structure, and a method of using a laminate structure. In the various embodiments of the present disclosure, the laminate structure comprises a substrate and a sheet layer having a melamine-based resin impregnated therein. More specifically, the sheet layer is coupled to the substrate by applying heat and pressure to the sheet layer and substrate for a predetermined duration thereby forming a Thermally-Fused Melamine (TFM) laminate structure.

Traditional TFM laminate structures generally use either medium-density fibreboard (MDF) or particleboard as a substrate. At least some known MDF and particleboard uses a urea formaldehyde resin binder, which may emit toxic formaldehyde to the environment. Further, traditional MDF and particleboard has a tendency to retain moisture thereby rendering it unsuitable for exterior use, and may be susceptible to rot and termite damage.

In the various embodiments of the present disclosure, the substrates used to fabricate laminate structures as described herein have a composition that solves these common problems associated with traditional MDF and particleboard. More specifically, the substrate used herein comprises wood, phenolic resin, biocide, and a water repellant agent. The phenolic resin acts as a binder for the composition used to fabricate the substrate, biocide (e.g., zinc borate) provides rot and corrosion resistance properties to the substrate, and the water repellant agent enables the substrate to be rated for use in high moisture environments. In one embodiment, the substrate used to form the laminate structures as described herein is Extira®. However, it has been found that tight process controls are required to laminate sheet layers to Extira® substrates at a cost-effective success rate.

It is believed, without being bound by any particular theory, that the properties and unique composition of the substrate described herein facilitates narrowing and/or completely changing the scope of acceptable process conditions that may be used to form the laminate structures described herein on a consistent basis when compared to process conditions used to fabricate traditional particleboard and fibreboard TFM. Further, factors such as the ambient conditions of the surrounding environment and type and thickness of sheet layers used affect the scope of acceptable process conditions that may be used to successfully fabricate laminate structures.

Once the laminate structures have been fabricated, they undergo a 100 percent visual inspection. As used herein, the terms “success”, “successful”, and “successfully” are defined as a laminate structure fabricated as described herein having a lack of at least one of clouding and veining defined therein, and/or delamination of the structure (i.e., A-grade). Also as used herein “fail”, “failure”, or “failed” is defined as a laminate structure fabricated as described herein that has clouding and/or veining defined therein that renders no portion of the laminate structure salvageable (i.e., D-grade or scrap).

As such, embodiments of the present disclosure provide for laminate structures composed primarily of wood that have improved durability, reliability, and aesthetic appearance over traditional particleboard and fibreboard TFM, and process conditions for fabricating such laminate structures with a nearly 100% success rate.

### Substrate

The substrate comprises wood with any suitable additives that enables the laminate structure to function as described herein. More specifically, the substrate is formed from a composition that comprises any suitable combination of wood with additives such as phenolic resin, biocide (e.g., zinc borate), and a water repellant agent. The composition is then pressed and heated to a temperature that facilitates curing the phenolic resin and forming the substrate having any suitable dimensions that enable the laminate structure to function as described herein. As used herein, the term “wood” is used broadly to refer to any wood or wood byproduct such as, but not limited to, sawdust, wood chips, sawmill shavings, and wood fiber.

The phenolic resin may be any suitable synthetic polymer formed by the reaction of phenol or substituted phenol with formaldehyde that enables the laminate structure to function as described herein. Non-limiting examples of suitable phenolic resins include phenol-formaldehyde, resorcinol-formaldehyde, resols, and novolac resins. The biocide may be any suitable substance that inhibits the growth of fungi, mold, algae, lichens, mildew, and/or bacteria. Non-limiting examples of suitable biocides include copper oxine (also known as copper oxene, Bis (8-ox-yquinoline) copper, copper 8-hydroxyquinoline, or copper 8-hydroxyquinolate), zinc stearate, calcium borate, zinc borate, barium borate, zinc omadine, zinc omadine/zinc oxide mix, sub 10 micron copper powder, and mixtures thereof In one embodiment, the biocide is zinc borate. Further, water repellant agents are generally known in the art. A non-limiting example of a suitable water repellant agent includes wax.

In any of the various embodiments of the present disclosure, the wood concentration is greater than about 85 percent, greater than about 86 percent, greater than about 87 percent, greater than about 88 percent, greater than about 89 percent, or greater than about 90 percent by weight based on the weight of the substrate. In some other embodiments, the additive concentration is less than about 15 percent, less than about 14 percent, less than about 13 percent, less than about 12 percent, less than about 11 percent, or less than about 10 percent by weight based on the weight of the substrate.

In any of the various embodiments of the present disclosure, the substrate has a thickness of from about 0.5 inch to about 1.5 inch, from about 0.625 inch to about 1.25 inch, or from about 0.75 inch to about 1.0 inch. Further, in any of the various embodiments of the present disclosure, the substrate has a density of from about 40 lbs/ft³ to about 50 lbs/ft³, from about 41 lbs/ft³ to about 49 lbs/ft³, from about 45 lbs/ft³ to about 48 lbs/ft³, or from about 46 lbs/ft³ to about 48 lbs/ft³. In some embodiments, the substrate is Extira® (“Extira” is a registered trademark of JELD-WEN, Inc. of Klamath Falls, Oreg.). Generally, Extira is manufactured in sizes of about 49 inch by about 97 inch, of about 49 inch by about 194 inch, or about 25 inch by about 194 inch, and in thicknesses of about 0.5 inch, about 0.625 inch, about 0.75 inch, about 1.0 inch, and about 1.25 inch.

### Sheet Layer

The sheet layer may comprise any suitable decorative sheet that enables the laminate structure to function as described herein. In some embodiments, the sheet layer comprises melamine decorative paper having at least one of a design, color, and/or texture on one side of the paper and a melamine-based resin impregnated therein. As such, when heat and pressure is applied to the sheet layer and the substrate, the melamine-based resin cures and facilitates forming a cross-linked bond between the sheet layer and the substrate.

An example of a suitable melamine-based resin includes, but is not limited to, melamine-urea. In some embodiments, only the melamine-urea impregnated within the sheet layer is used to bond the sheet layer to the substrate. In any of the various embodiments of the present disclosure, the concentration of melamine-based resin in the sheet layer is from about 50 percent to about 70 percent, from about 55 percent to about 65 percent, or from about 57.5 percent to about 62.5 percent by weight based on the weight of the sheet layer.

In some embodiments, the thickness of the sheet layer may be based on the color, texture, or type of wood grain used on the decorative side of the sheet layer. For example, sheet layers having a dark color and/or dark wood grain are generally thicker than sheet layers having a light color and/or light wood grain. More specifically, in any of the various embodiments of the present disclosure, the sheet layer has a thickness of from about 5 mils to about 10 mils, from about 6 mils to about 9 mils, or from about 6 mils to about 8 mils. In any of the various embodiments of the present disclosure, the sheet layers used to form the laminate structures may be manufactured by companies such as Formica®, Wilsonart®, Coveright®, Arclin®, and Pionite®.

### Laminate Structure

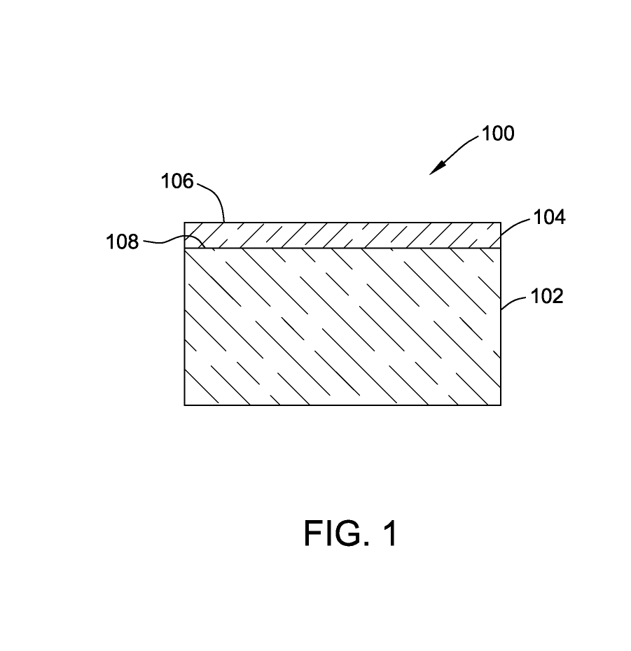

Referring now to FIG. 1, a laminate structure 100 fabricated as described herein is shown. Laminate structure 100 includes a substrate 102 and a sheet layer 104 coupled to substrate 102. More specifically, sheet layer 104 includes a first side 106 and a second side 108 opposing first side 106. In the exemplary embodiment, first side 106 comprises at least one of a design, color, and/or texture defined therein, and second side 108 comprises an adhesive impregnated therein. More specifically, in accordance with embodiments of the present disclosure, second side 108 comprises a melamine-based resin (not shown) impregnated therein. During fabrication, the adhesive facilitates coupling second side 108 to substrate 102 and more specifically, facilitates coupling sheet layer 104 to substrate 102. Optionally, sheet layers 104 may be coupled to more than one exposed surface of substrate 102.

In any of the various embodiments of the present disclosure, the laminate structure has a thickness of about 0.5 inch±20 mils, about 0.625 inch±20 mils, about 0.75 inch±20 mils, about 1.0 inch±20 mils, and about 1.25 inch±20 mils.

### Methods of Formation and Use

A method of forming the laminate structure is also described herein. The method includes selecting a substrate as described above and selecting a sheet layer as described above. The sheet layer is then laminated to the substrate by applying heat and pressure to the sheet layer and substrate for a predetermined duration. More specifically, the substrate and sheet layer are pressed between rigid steel plates at the appropriate pressure and for the predetermined duration. Applying heat and pressure to the sheet layer and substrate facilitates coupling the sheet layer to the substrate and forming a cross-linked bond therebetween.

In any of the various embodiments of the present disclosure, the process conditions for forming the laminate structure as described herein may vary depending on any number of factors. For example, factors that can determine the process conditions for forming laminate structures include, but are not limited to, the ambient conditions of the surrounding environment (e.g., the relative humidity and temperature), and the sheet layer thickness. More specifically, when the relative humidity, temperature, and/or sheet layer thickness increases, at least one of the heat, pressure, and/or predetermined duration are modified to enable the laminate structure to be formed at or above an acceptable success rate. Even more specifically, at least one of the heat, pressure, and/or the predetermined duration are increased within predetermined process condition ranges to accommodate an increase in ambient conditions and/or sheet layer thickness. For example, the process temperature may be raised by about 5° F. to about 7° F. when a black sheet layer having a thickness of about 0.2 millimeters (mm) (0.0788 inch) is used when compared to when a white sheet layer having a thickness of about 0.157 mm (0.069 inch) is used. In some embodiments, the ambient conditions that generate the highest success rate are a temperature of from about 75° F. to about 80° F., and a relative humidity of from about 45% to about 55%.

In any of the various embodiments of the present disclosure, the temperature of the heat applied to form the laminate structure is from about 339° F. to about 375° F., from about 350° F. to about 375° F., from about 360° F. to about 375° F., from about 365° F. to about 374° F., or from about 368° F. to about 372° F. Further, in any of the various embodiments of the present disclosure, the pressure is from about 22 bar to about 35 bar, from about 23 bar to about 32 bar, from about 23 bar to about 30 bar, or from about 23 bar to about 28 bar. Even further, in any of the various embodiments of the present disclosure, the predetermined duration is from about 12 seconds to about 22 seconds, from about 13 seconds to about 20 seconds, from about 13 seconds to about 18 seconds, or from about 13 seconds to about 15 seconds.

By using the process conditions described above, laminate structures of the present disclosure may be formed with a success rate of at least about 90 percent, at least about 95 percent, at least about 98 percent, or at least about 99 percent.

In some embodiments, the laminate structures of the present disclosure may be installed in a non-structural construction application, that is in a non load-bearing application. Further, the laminate structures may be installed in a high-moisture area such as, but not limited to, areas exposed to precipitation and areas prone to spills, leaks, and/or plumbing mishaps.

### EXAMPLES

The following non-limiting simulations are provided to further illustrate the present disclosure.

As shown by the process condition data in Table 1, laminate structures (boards) as described herein were fabricated and tested. The laminate structures were fabricated using different process conditions depending on the ambient conditions and type of sheet layer laminated to the substrate. More specifically, the process conditions were modified in accordance with an increase in ambient temperature and/or ambient relative humidity throughout the day of fabrication. Further, the process conditions were modified in accordance with varying thicknesses in the sheet layers laminated to the substrate. As such, at least one of the process temperature, process pressure, and process duration were increased to accommodate increases in the sheet layer thickness, ambient temperature, and ambient relative humidity.

The substrates used to fabricate the laminate structures were as-received boards of Extira® having a width of 49 inch, a length of 97 inch, and a thickness of 0.75 inch. Further, the sheet layers used were as-received melamine decorative paper from Formica® and Coveright® of varying colors and thicknesses. For example, the White sheet layers had a thickness of about 0.0619 inch, the Cherry/White sheet layers had a greater thickness than the White sheet layers, and the Cherry sheet layers had a greater thickness than the Cherry/White sheet layers.

Further, the laminate structures were fabricated on three different days. On Day 1, the ambient temperature ranged from 69-93° F., and the relative humidity ranged from 41-79%. On Day 2, the ambient temperature ranged from 61-89° F., and the relative humidity ranged from 47-100%. On Day 3, the ambient temperature ranged from 64-82° F., and the relative humidity ranged from 55-84%. Accordingly, the process conditions used during Day 1 included a process temperature range of 339-355° F., a process pressure range of 25-35 bar, and the heat and pressure were applied for 16 seconds. The process conditions used during Day 2 included a process temperature range of 347-372° F., a process pressure range of 22-32 bar, and the heat and pressure were applied for 15 seconds. The process conditions used during Day 3 included a process temperature range of 355-370° F., a process pressure range of 22-32 bar, and the heat and pressure were applied for 14 seconds.

TABLE 1

| | | | | | Ambient | | |
|---|---|---|---|---|---|---|---|
| Process T | Process P | Duration | Total | Sheet | T Range | Ambient RH | Failure |
| Range (° F.) | Range (bar) | (seconds) | Boards | Layer | (° F.) | Range (%) | Rate (%) |
| 339-355 | 25-35 | 16 | 40 | White | 69-93 | 41-79 | 0 |
| 347-372 | 22-32 | 15 | 110 | White | 61-89 | 47-100 | 0 |
| 347-372 | 22-32 | 15 | 30 | Cherry/ | 61-89 | 47-100 | 0 |
| | | | | White | | | |
| 347-372 | 22-32 | 15 | 16 | Cherry | 61-89 | 47-100 | 0 |
| 355-370 | 22-32 | 14 | 335 | White | 64-82 | 55-84 | 0 |
| 355-370 | 22-32 | 14 | 94 | Cherry/ | 64-82 | 55-84 | 0 |
| | | | | White | | | |
| 355-370 | 22-32 | 14 | 32 | Cherry | 64-82 | 55-84 | 0 |

Accordingly, using the process conditions as shown above facilitated fabricating the laminate structures with a 0 percent failure rate. Further, it was found that generally a higher ambient temperature required a larger pressure and a longer duration to be used to produce 0 percent failure, and generally a higher relative humidity required a higher temperature to be used to produce 0 percent failure. Further, it was found that using sheet layers having a greater thickness generally required applying a greater pressure to produce 0 percent failure.

As shown by the process condition data in Table 2, laminate structures using traditional materials were fabricated and tested. More specifically, The substrates used to fabricate the laminate structures were medium-density fibreboard (MDF)/particleboard, particleboard, and Medex®, which is a moisture resistant MDF (“Medex” is a registered trademark of Sierrapine, a California Corporation). The MDF/particleboard had a width of 36 inch, a length of 84 inch, and a thickness of 1.75 inch, and the particleboard and Medex® each had a width of 60 inch, a length of 96 inch, and a thickness of 0.75 inch. Further, the MDF/particleboard laminate structures were fabricated on Day 1, and the particleboard and Medex® laminate structures were fabricated on Day 3. The process conditions used for the MDF/particleboard laminate structures on Day 1 included a process temperature range of 340-355° F., a process pressure range of 25-35 bar, and the heat and pressure were applied for 15 seconds. The process conditions used for the particleboard and Medex® laminate structures included a process temperature range of 355-370° F., a process pressure range of 25-35 bar, and the heat and pressure were applied for 14 seconds.

Further, the sheet layers used were as-received melamine decorative paper from Formica® and Coveright® of varying colors and thicknesses. For example, the White sheet layers had a thickness of about 0.0619 inch, the Cherry/White sheet layers had a greater thickness than the White sheet layers, the Cherry sheet layers had a greater thickness than the Cherry/White sheet layers, and the Maple and Anigre sheet layers had a substantially similar thickness as the White sheet layers.

TABLE 2

| Process T Range (° F.); | | | | Ambient | | |
|---|---|---|---|---|---|---|
| P Range (bar); | | Total | Sheet | T Range | Ambient RH | Failure |
| Duration (s) | Substrate | Boards | Layer | (° F.) | Range (%) | Rate (%) |
| 340-355; 25-35; 15 | MDF/particle | 8 | Maple | 69-93 | 41-79 | 75.0 |
| | board | | | | | |
| 340-355; 25-35; 15 | MDF/particle | 3 | Anigre | 69-93 | 41-79 | 0 |
| | board | | | | | |
| 355-370; 25-35; 14 | Particleboard | 2 | White | 64-82 | 55-84 | 0 |
| 355-370; 25-35; 14 | Particleboard | 94 | Cherry/ | 64-82 | 55-84 | 0 |
| | | | White | | | |
| 355-370; 25-35; 14 | Particleboard | 68 | Cherry | 64-82 | 55-84 | 0 |
| 355-370; 25-35; 14 | Medex ® | 38 | White | 64-82 | 55-84 | 10.5 |

Accordingly, using process conditions to fabricate traditional laminate structures that were the same as the process conditions used to fabricate laminate structures as described herein produced failed laminate structures at unacceptable rates during some test runs. More specifically, laminate structures using a Medex® substrate and White sheet layers produced a failure rate of 10.5 percent, and laminate structures using an MDF/particleboard substrate and Maple sheet layers produced a failure rate of 75 percent.

### Screw Withdrawal Testing

Laminate structures were fabricated as described above, and several of the laminate structures were subjected to an accelerated aging cycle per ASTM D1037, Section 7.3.5 with a modified Step 4. Step 1 of the accelerated aging cycle included immersing the specimens in water at 120±3° F. for 1 hour; step 2 included exposing the specimens to steam and water vapor at 200±5° F. for 3 hours; step 3 included freezing the specimens at 10±5° F. for 20 hours; step 4 included heating the specimens at 210±3° F. for 3 hours; step 5 included exposing the specimens to steam and water vapor at 200±5° F. for 3 hours; and step 6 included heating the specimens at 210±3° F. for 18 hours. Step 4 deviated from the standard requirement by being outside of the 210±3° F. tolerance by about 5° F. for about 50 minutes. Once the six steps were completed, the specimens were conditioned at 68±6° F. and 65±2% relative humidity for at least 48 hours prior to testing.

As shown by the experimental results in Tables 3 and 4, five as-received laminate structures and five accelerated aged laminate structures were evaluated per ASTM D1037, Section 16 for the amount of force required to withdraw a screw from the specimens. More specifically, the specimens were tested in an ambient laboratory environment of about 73.4±3.6° F. and about 50±5% relative humidity. Further, the specimens had a width of about 3 inch, a length of about 4 inch, and an average thickness of about 0.759 inch, and a screw was threaded two-thirds of an inch into a 0.125 inch diameter lead hole defined within the specimens. Screw withdrawal testing was done by inserting the specimen into a specimen holder with the screw head facing up, the screw head was pulled in tension by a slotted fixture attached to a cross head at a constant rate of 0.06 inch/minute±50%, and the maximum load required to withdraw the screw was measured.

TABLE 3

| Specimen | Conditioning | Ultimate | Moisture |
|---|---|---|---|
| No. | Type | Load (lbs) | Content (%) |
| 49545 | Dry (As-Received) | 327 | 7 |
| 49546 | Dry (As-Received) | 327 | 6 |
| 49547 | Dry (As-Received) | 304 | 6 |
| 49548 | Accelerated Aged | 344 | 5 |
| 49549 | Accelerated Aged | 335 | 5 |
| 49550 | Accelerated Aged | 302 | 5 |
| 49551 | Accelerated Aged | 305 | 5 |
| 49554 | Accelerated Aged | 365 | 5 |
| 49989 | Dry (As-Received) | 340 | 7 |
| 49990 | Dry (As-Received) | 414 | 7 |

TABLE 4

| | Dry | |
|---|---|---|
| | (As-Received) | Accelerated |
| | (lbs) | Aged (lbs) |
| Average | 342 | 330 |
| Minimum | 304 | 302 |
| Maximum | 414 | 362 |
| Maximum % Difference | 21% | 11% |

Accordingly, the specimens subjected to the accelerated aging cycle produced substantially similar screw withdrawal test results when compared to the as-received specimens. More specifically, specimens subjected to accelerated aging produced an average ultimate load required to withdraw the screw of only about 12 lbs less than the as-received specimens, produced only a 2 lbs difference in minimum load measured, and the accelerated aged specimens exhibited less deviation between upper and lower ultimate load results.

### Falling Ball Impact Testing

As shown by the experimental results in Table 5, five as-received laminate structures and five accelerated aged laminate structures were evaluated per ASTM D1037, Section 21 to determine failure of the tested specimens under falling ball impact. More specifically, a steel ball having a diameter of about 2 inch was dropped onto the specimens at a height of 1 inch, and subsequent drops were made in 1 inch increments until a drop height of 16 inch was reached.

TABLE 5

| | Pre-Conditioning | | Post-Conditioning | | |
|---|---|---|---|---|---|
| | Measurements | | Measurements | | |
| | (Dry As-Received) | | (Accelerated Aged) | | |
| Specimen | Thickness | | Thickness | | Impact |
| No. | (in.) | Mass (g) | (in.) | Mass (g) | Failure |
| 49561 | 0.761 | 868.2 | | | No |
| 49562 | 0.760 | 875.6 | | | No |
| 49563 | 0.757 | 909.2 | | | No |
| 49564 | 0.761 | 899.0 | | | No |
| 49565 | 0.758 | 916.2 | 0.822 | 888.8 | No |
| 49566 | 0.759 | 882.7 | 0.798 | 860.1 | No |
| 49567 | 0.757 | 879.9 | 0.800 | 853.9 | No |
| 49568 | 0.759 | 877.4 | 0.803 | 853.0 | No |
| 49569 | 0.760 | 902.8 | 0.799 | 878.6 | No |
| 49994 | 0.758 | 893.4 | | | No |

Accordingly, neither the as-received specimens nor the accelerated aged specimens failed under falling ball impact. As such, the accelerated aged specimens exhibited identical strength under falling ball impact when compared to the as-received specimens.

### Water Absorption and Thickness Swelling Testing

As shown by the experimental results in Tables 6 and 7, ten as-received laminate structures were evaluated per ASTM D1037, Section 23 to determine thickness swelling and water absorption of specimens submerged in water. The specimens had a length and width of about 12 inch, and a thickness of about 0.75 inch. Further, five of the specimens (50149-50153) were submerged in a horizontal orientation, and five of the specimens (50155-50159) were submerged in a vertical orientation.

TABLE 6

| | | | | Post 2 Hour | | Post 22 Hour | |
|---|---|---|---|---|---|---|---|
| | Pre-Test Data | | | Submersion | | Submersion | |
| Speci- | Moisture | Avg | | Avg | | Avg | |
| men | Content | Thickness | Mass | Thick | Mass | Thick | Mass |
| No. | (%) | (in.) | (g) | (in.) | (g) | (in.) | (g) |
| 50149 | 7.7 | 0.7628 | 1434 | 0.7625 | 1441 | 0.7633 | 1455 |
| 50150 | 7.6 | 0.7609 | 1394 | 0.7606 | 1401 | 0.7616 | 1415 |
| 50151 | 7.1 | 0.7637 | 1419 | 0.7631 | 1427 | 0.7642 | 1441 |
| 50152 | 7.5 | 0.7626 | 1434 | 0.7626 | 1438 | 0.7633 | 1452 |
| 50153 | 7.8 | 0.7616 | 1435 | 0.7614 | 1439 | 0.7622 | 1454 |
| 50155 | 7.1 | 0.7624 | 1439 | 0.7623 | 1443 | 0.7633 | 1458 |
| 50156 | 7.3 | 0.7624 | 1385 | 0.7623 | 1390 | 0.7634 | 1406 |
| 50157 | 7.5 | 0.7626 | 1418 | 0.7623 | 1423 | 0.7635 | 1439 |
| 50158 | 7.0 | 0.7639 | 1425 | 0.7633 | 1430 | 0.7646 | 1447 |
| 50159 | 7.0 | 0.7607 | 1414 | 0.7601 | 1418 | 0.7614 | 1435 |

TABLE 7

| | Post 2 Hour Submersion | | Post 22 Hour Submersion | | |
|---|---|---|---|---|---|
| | H₂O | | H₂O | | |
| | Absorbed | Thickness | Absorbed | Thickness | Moisture |
| Specimen | By Weight | Swelling | By Weight | Swelling | Content |
| No. | (%) | (%) | (%) | (%) | (%) |
| 50149 | 0.5 | −0.03 | 1.4 | 0.07 | 7.4 |
| 50150 | 0.5 | −0.05 | 1.5 | 0.09 | 7.8 |
| 50151 | 0.5 | −0.07 | 1.5 | 0.07 | 7.6 |
| 50152 | 0.3 | 0.00 | 1.2 | 0.09 | 7.9 |
| 50153 | 0.3 | −0.03 | 1.3 | 0.07 | 8.0 |
| 50155 | 0.3 | 0.00 | 1.4 | 0.12 | 8.0 |
| 50156 | 0.3 | −0.01 | 1.5 | 0.12 | 8.1 |
| 50157 | 0.3 | −0.05 | 1.4 | 0.12 | 8.1 |
| 50158 | 0.3 | −0.09 | 1.5 | 0.08 | 8.0 |
| 50159 | 0.3 | −0.07 | 1.5 | 0.09 | 8.2 |

Accordingly, the specimens submerged in a horizontal orientation had an average post 22 hour water absorption of no more than about 1.5% by weight and had an average post 22 hour thickness swelling of less than about 0.10%. Further, the specimens submerged in a vertical orientation had an average 22 hour water absorption of no more than about 1.5% by weight and had an average post 22 hour thickness swelling of less than about 0.15%.

As shown by the experimental results, the process conditions used herein enabled fabrication of the laminate structures at a 0 percent failure rate. Further, as shown by the experimental results, the laminate structures fabricated as described herein and subjected to an accelerated aging cycle exhibited substantially similar test results when compared to as-received laminate structures. For example, the accelerated aged laminate structures exhibited substantially similar strength and thus very little density reduction, and produced identical falling ball impact test results when compared to the as-received laminate structures. Further, the laminate structures exhibited very little moisture retention even when submerged in water for about 24 hours. It is believed, based on the experimental evidence to date, that the process conditions described herein produce TFM laminate structures nearly at or about a 100 percent success rate, and that the laminate structures exhibit improved physical characteristics over traditional TFM laminate structures fabricated from particleboard and fibreboard.

This written description uses examples to disclose various embodiments, including the best mode, and also to enable any person skilled in the art to practice the various embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A laminate structure comprising:
a substrate comprising wood, phenolic resin, biocide, and a water repellant agent; and
a sheet layer coupled to the substrate, wherein the sheet layer comprises a melamine-based resin impregnated therein.

2. The laminate structure in accordance with claim 1, wherein the wood concentration is greater than about 85 percent by weight.

3. The laminate structure in accordance with claim 1, wherein the substrate does not comprise urea formaldehyde resin.

4. The laminate structure in accordance with claim 1, wherein the biocide is zinc borate.

5. The laminate structure in accordance with claim 1, wherein the melamine-based resin comprises melamine-urea.

6. The laminate structure in accordance with claim 1, wherein the substrate has a thickness of from about 0.5 inch to about 1.5 inch.

7. The laminate structure in accordance with claim 1, wherein the sheet layer has a thickness of from about 5 mils to about 10 mils.

8. The laminate structure in accordance with claim 1, wherein the sheet layer comprises an adhesive side coupled to the substrate and a decorative side opposing the adhesive side.

9. A method for forming a laminate structure, said method comprising:
selecting a sheet layer that comprises a melamine-based resin;
selecting a substrate that comprises wood, phenolic resin, biocide, and a water repellant agent;
applying heat and pressure, the heat applied at a temperature of from about 339° F. to 375° F. and the pressure applied at about 23 bar to about 35 bar, to the substrate and the sheet layer for a predetermined duration of from about 12 seconds to about 22 seconds; and
coupling the sheet layer to the substrate to form the laminate structure.

10. The method in accordance with claim 9, wherein applying heat and pressure comprises modifying at least one of the heat, the pressure, or the predetermined duration based on ambient conditions of a surrounding area.

11. The method in accordance with claim 10, wherein modifying at least one of the heat, the pressure, and the predetermined duration comprises increasing the at least one of the heat, the pressure, or the predetermined duration when at least one of an ambient temperature or an ambient relative humidity increases.

12. The method in accordance with claim 9, wherein applying heat and pressure comprises modifying at least one of the heat, the pressure, or the predetermined duration based on a thickness of the sheet layer.

13. The method in accordance with claim 12, wherein modifying at least one of the heat, the pressure, or the predetermined duration comprises increasing the at least one of the heat, the pressure, or the predetermined duration as the sheet layer thickness increases.

14. The method in accordance with claim 9, wherein applying heat and pressure comprises heating the substrate and the sheet layer at a temperature of from about 360° F. to about 375° F.

15. The method in accordance with claim 9, wherein applying heat and pressure comprises applying the pressure to the substrate and the sheet layer at from about 23 bar to about 32 bar.

16. The method in accordance with claim 9, wherein applying heat and pressure comprises applying at least one of heat and pressure for a predetermined duration of from about 13 seconds to about 18 seconds.

17. The method in accordance with claim 9, wherein applying heat and pressure comprises forming a cross-linked bond between the substrate and the sheet layer.

18. The method in accordance with claim 9 further comprising forming the laminate structure with a success rate, as determined by the lack of at least one of clouding or veining in the laminate structure, of at least about 90 percent.

19. A method for using a laminate structure, said method comprising:
selecting a laminate structure including:
a substrate comprising wood, phenolic resin, biocide, and a water repellant agent; and
a sheet layer coupled to the substrate, wherein the sheet layer comprises a melamine-based resin impregnated therein; and
installing the laminate structure in a non-structural construction application.

20. The method in accordance with claim 19, wherein installing the laminate structure comprises installing the laminate structure in a high-moisture area.
